(19) United States
(12) Patent Application Publication
(10) Pub. No.: US 2002/0055889 A1
(43) Pub. Date: May 9, 2002

(54) Order made system

(75) Inventor: Masao Nakagawa, Taito-ku (JP)

Correspondence Address: Merchant & Gould P.C., P.O. Box 2903, Minneapolis, MN, 55402-0903, US

(73) Assignee: Nakagawa & Co, Ltd.

(21) Appl. No.: 09/852,374

(22) Filed: May 10, 2001

(30) Foreign Application Priority Data
Nov. 7, 2000 (JP) 2000-338746

(51) Int. Cl. G06F 17/60

(52) U.S. Cl. 705/27

(57) ABSTRACT

A made-to-order system in which made-to-order is concluded with a little risk while simplicity of mail correspondence of catalog etc., transacting in a wide area and further use of speedy dealing of electric commerce transaction is desirable. Therefore, good specification which customer desires is mutually understood in easy interactive form by close communication of information terminal T with made-to-order management server SV, design sample in which recognition should be common is downloaded to information terminal T and confirmation means for confirmation whether or not accepted order contract based on design sample is provided.

### FIELD OF THE INVENTION

The present invention relates to a made-to-order system in electric commerce transaction.

### BACKGROUND OF THE INVENTION

In conventional electric commerce transaction, electric commerce transaction is still a mail-order selling for ready-made articles. Changes are that mail task is merely omitted and that ordering time and response time of acceptance or unacceptance corresponding to ordering time are shortened and that means of collecting charges is changed.

There were the following problems in a case of electric commerce transaction in a view to made-to-order articles.

Firstly, it is difficult to specify requirement specification of customer, and thereby business negotiation is not concluded or cause of trouble.

Secondly, risk of cancel is large with the made-to-order articles and it is difficult to objectively judge whether responsibility lies with the customer or the business owner. In most cases, responsibility rests with the business owner's side.

Accordingly, the made-to-order is generally high-quality commerce transaction in common sense as well as precondition that there is a shop, a shop clerk and reliable relationship of the shop clerk and the customer is indispensable.

The reliable relationship includes the following requirements which are indispensable.

Firstly, business negotiation is concluded by complete allowance of requirement specification of the customer.

Secondly, if a made-to-order product produced according to made-to-order is cancelled, it should incurable be known by the customer that it is difficult to resell cash the made-to-order product.

When the order good is cancelled, it is objectively judged whether responsibility lies with the customer or the business owner. Then, the side that is found to be at fault is required to claim damages and suffers penalty under civil law.

In brief, there are the shop which is not evaded at the owner business side and social confidence which does not desire to be lost as well as there is social confidence that does not desire to be lost or damages at the customer side as well. Made-to-order is concluded while these multiple effects balance exquisitely.

### SUMMARY OF THE INVENTION

This invention has been made to solve the above problems, and it is therefore an object of the present invention to provide a made-to-order system in which made-to-order is concluded with a little risk while simplicity of mail correspondence of catalog etc., transacting in a wide area and further use of speedy of electric commerce transaction.

According to the present invention, there is provided a made-to-order system which comprises an accepted order means; an accepted order content confirmation means; a design sample production means for producing design sample including image data based on specification data an accepted order; a design sample transmitting means for transmitting the design sample to a customer who ordered; and a confirmation means for confirming whether or not accepted order contract is accepted based on the design sample in an electric commerce transaction.

Contract by complete allowance based on requirement specification of a customer who lives in far place is concluded. If an order good produced according to contract of made-to-order is cancelled after that, it is easy to incurable know to the customer side that it is difficult to resell cash of the made-to-order product. If an order good is cancelled, it is hard for become trouble to arise since responsibility of customer or business owner can objectively be judged.

Therefore, made-to-order can be concluded with a little risk while simplicity of mail correspondence of catalog etc., transacting in a wide area and further use of speedy of electric commerce transaction.

According to the present invention, there is provided a made-to-order system, in which the system comprises the accepted order content confirmation means to be capable of specifying existence of special specification or content of special specification, a specific pattern; dimension; color; figure; and/or good name on a screen of homepage, and an image synthetic processing means for overlapping a database storing specification data of existing or new special specification and specific pattern so as to search them freely and specification data cited from the database with a half completed model image by a computer graphic.

Thereby, design sample can immediately be presented so long as a specification pattern or content of special specification is not original.

Design sample is displayed with a little effort if specification is clear even if specification pattern or menu of special specification is original.

Further, since design sample established once is added to database, it becomes possible to instantaneously present design sample for same or similar specification.

Therefore, since new repertory increases by continuing business, it is possible to expect further development of made-to-order.

According to the present invention, there is provided a made-to-order system in which the system comprises a manufacturing arrangement means for having manufacturing instruction form in which design sample is main.

Thereby, manufacturing arrangement is speedy, surely, and accurately available corresponding to order.

According to the present invention, there is provided a made-to-order system in which the system deals with a stage good for festival or various events.

Thereby, it is possible to cheaply provide with high quality product in a short scheduled delivery date for shortening trouble and the time required to get a large quantity of agreed accepted order contract.

Therefore, it is possible to deal with special demand of a stage good of high tendency to occurrence of prominent demand at the far place in limited period.

According to the present invention, there is provided a made-to-order system in which a family crest is put on a product to be applied.

Thereby, traditional feeling is easily satisfied.

According to the present invention, there is provided a made-to-order system in which Edo letter is put on a product to be applied. Thereby, traditional feeling is easily satisfied.

According to the present invention, there is provided a made-to-order system in which the system comprises:

an accepted order means for accepting order of design creation for a background design to be displayed on a display screen provided on the portable remote terminal; and

a fee collection means for collecting a fee for producing design of the image data by downloading image data of design creation created according to the ordering to the portable remote terminal by a customer or a fee for distributing an existing design in an information communication system being capable of using a portable remote terminal which can access Internet.

Thereby, the customer who uses the portable remote terminal can easily order charge design to set the dedicated or favorite the wallpaper background design in the display screen, ordered content is instantaneously displayed on the display screen of portable remote terminal and displayed order is fixed.

According to the present invention, there is provided a made-to-order system in which the system comprises an image for producing means of a slip of paper printed with the name of a pilgrim for supplying design in which character or letter that customer desires is written and design has taste of the slip of paper printed with the name of the pilgrim.

Thereby, design having taste of the traditional and attractive the slip of paper printed with the name of the pilgrim is instantly displayed on a display screen of the portable remote terminal to a person interested in a Japanese festival of Shinto shrine and design is fixed. Therefore, sales promotion of the design is available according to elevation of festival feeling.

The above and other objects, features, and advantages of the invention will become more apparent from the following description when taken in conjunction will the accompanying drawings.

### BRIEF DESCRIPTION OF THE DRAWINGS

FIG. 1 is a block diagram showing configuration of made-to-order system and relation connected with information terminal of present embodiment.

FIG. 2A shows a logical configuration diagram of customer DB in made-to-order system of FIG. 1.

FIG. 2B shows a logical configuration diagram of model DB FIG. 2C shows a logical configuration diagram of accepted order history DB.

FIG. 3A is a diagram of homepage screen of electric commerce transaction in made-to-order system 1 of FIG. 1.

FIG. 3B is a diagram of screen of customer registration page.

FIG. 4A is a diagram of screen of base good selection/order entrance page in made-to-order system 1 of FIG. 1

FIG. 4B is a diagram of screen of specification selection page.

FIG. 5 is a diagram of screen of ordering confirmation in made-to-order system of FIG. 1.

FIG. 6 is a flowchart of ordering in made-to-order system of FIG. 1.

FIG. 7 is a sequence chart when a customer registration is made to made-to-order system of FIG. 1.

FIG. 8 is a sequence chart when a registered customer selects a model and downloads design sample data in made-to-order system of FIG. 1.

### DESCRIPTION OF THE PREFERRED EMBODIMENT

Below, embodiment of made-to-order system in the present invention is described referring to drawings.

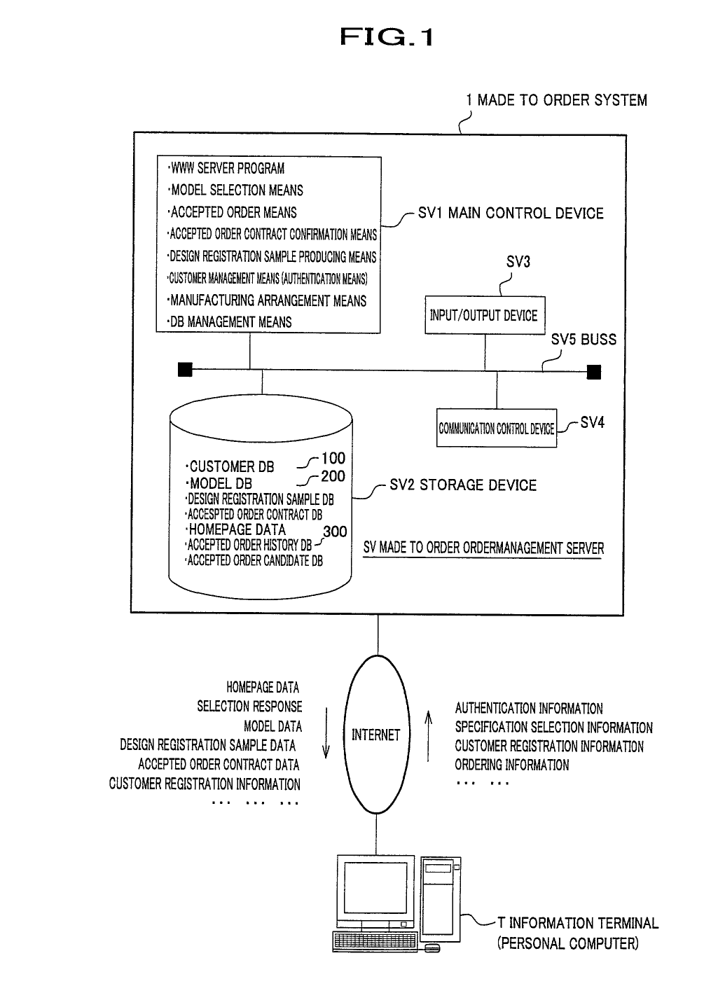

FIG. 1 is block diagram showing configuration of made-to-order system and relation connected with information terminal of present embodiment.

Outline of made-to-order system 1 is described.

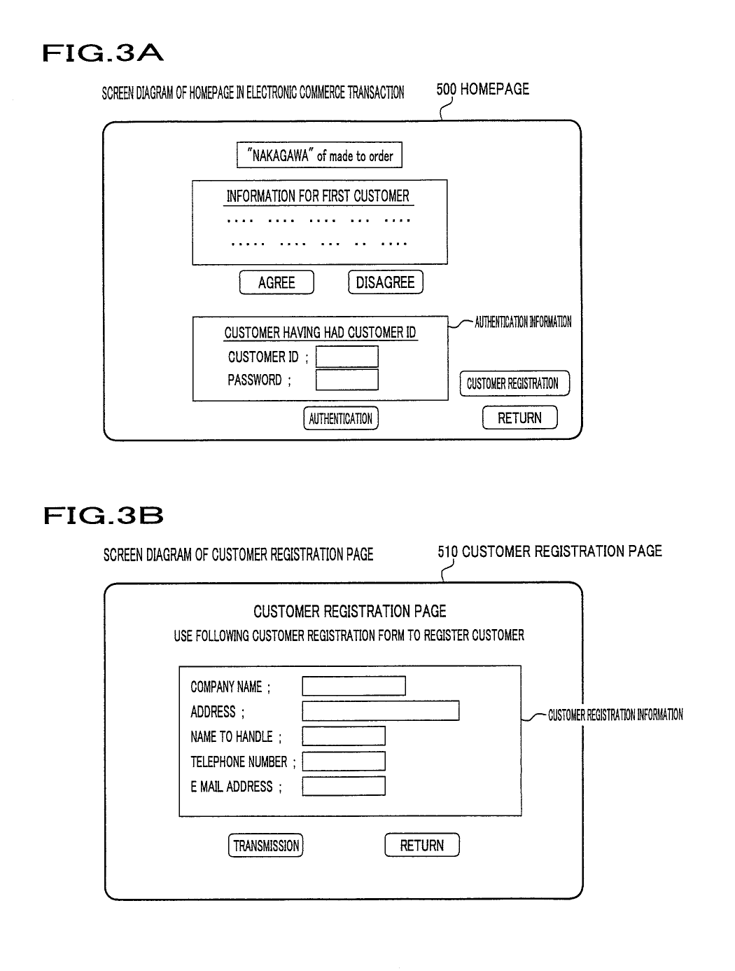

As shown in FIG. 1, made-to-order system 1 of present embodiment is system in which made-to-order management server SV of a business owner is at the core. Articles or design are sold between the made-to-order system 1 and an information terminal T of customer by Internet and particularly, producing and selling “Made-to-order product” which was hard to be concluded in conventional electric commerce transaction are handled. Homepage 500 of “Nakagawa of made-to-order” is opened (See FIG. 3).

Customer accesses homepage 500 with the information terminal T, interchanges necessary information for made-to-order management server SV, image-sets good specification as desired instantaneously or in short time, and carries out accepted order after having looked at design sample (hereinafter referred to as design sample) by computer graphics.

Items to be sold in the present embodiment are mainly stage goods of festival and various events. Item is lantern, slip of paper printed with name of pilgrim (will be described hereinafter) name seal of slip of paper printed with name of the pilgrim style, strap for cellular phone, jacket, shirt with neck of carp mouth (will be described hereinafter), long underwear, long underwear with pattern, waistcoat having front but no back, Japanese towel, tabi (Japanese socks), straw sandal, fan, or band, which is demanded related to Japanese festival of Shinto shrine.

“Slip of paper printed with name of pilgrim” and “Shirt with carp mouth shaped neck” are simply defined.

“Slip of paper printed with name of pilgrim” is card as “Incantation slip” sold with Japanese festival of Shinto shrine and slip made of paper whose size is length of 17.2 cm×side 5.7 cm in an rectangular shape as one example. There is “Slip of paper printed with name of pilgrim” in which frame is drawn on surface, ground color of inside of frame is colored in red, green, yellow, and dark-blue etc. and Edo letter of “Asakusa/shops lining passageway”, “Asakusa/Kaminari-mon”, “Three festivals”, “Do business”, “Fifth group (character of matoi)” or the like, or drawing pattern is drawn in black. There is design which copied to other accessories in basis of Edo letter or pattern of drawing drawn in black.

“Shirt with carp mouth shaped neck” is kind of stage clothes with pattern, round neck, semi-long sleeves, front button, and is worn by person who carries portable shrine “MIKOSHI” at festivals. There is “Tattoo shirt” with pattern on whole, which tattoo is imaged without front button.

These are sold in general marketing and, in present invention, “Made-to-order product” raise additional value can be accept order-produced and sold more easily and reasonably by putting unique name or pattern of drawing and family crest.

[Hardware]

Made-to-order system is described in detail.

As shown in FIG. 1, made-to-order management server SV has configuration in which main control device SV1, memory device SV2, input/output device SV3, and communication control device SV4 etc. are connected to bass SV5.

Main control device SV1 is configured by MPU (Micro Processing Unit) and RAM (Random Access Memory) etc., and controls made-to-order management server SV synthetically. In main control unit SV1, a WWW Server program, model selection means, accepted order means, accepted order contract confirmation means, design sample producing means, customer management means, authentication means, manufacturing arrangement means, DB management means etc. are started. (“DB” is abbreviation of database.)

Memory device SV2 is configured by hard disk device and optic magneto disk device, etc. Memory device SV2 stores customer DB 100, model DB 200, design sample DB, accepted order contract DB, homepage data, accepted order history DB 300, accepted order candidate DB etc. so as to search them freely.

Keyboard, mouse, and display device, etc. are connected to input/output device SV3 via I/O device. Communication control unit SV4 is configured by modem and DSU (Digital Service Unit) etc., and implements transmission and receipt of information by Internet.

[Program]

Each program started in main control device SV1 is described.

WWW server program is basement program providing with various kinds of information between server on Internet or customer (information terminal T) by HTTP (Hyper Text Transfer Protocol) and getting various kinds of information.

Model selection means selects item of good to be ordered, e.g., lantern or tabi based on requirement transmitted from information terminal T of customer and prepares for setting concrete and detail specification.

Model of state of rough sketch for coloring backlash for child is presented and drawing design and coloring which customer specifies are awaited.

To set specification is not only to specify color or figure but also to set shape or dimension and special specification of good. That is, any range can be set due to sufficient DB if range is matched to range of business.

Design sample producing means is described hereinafter.

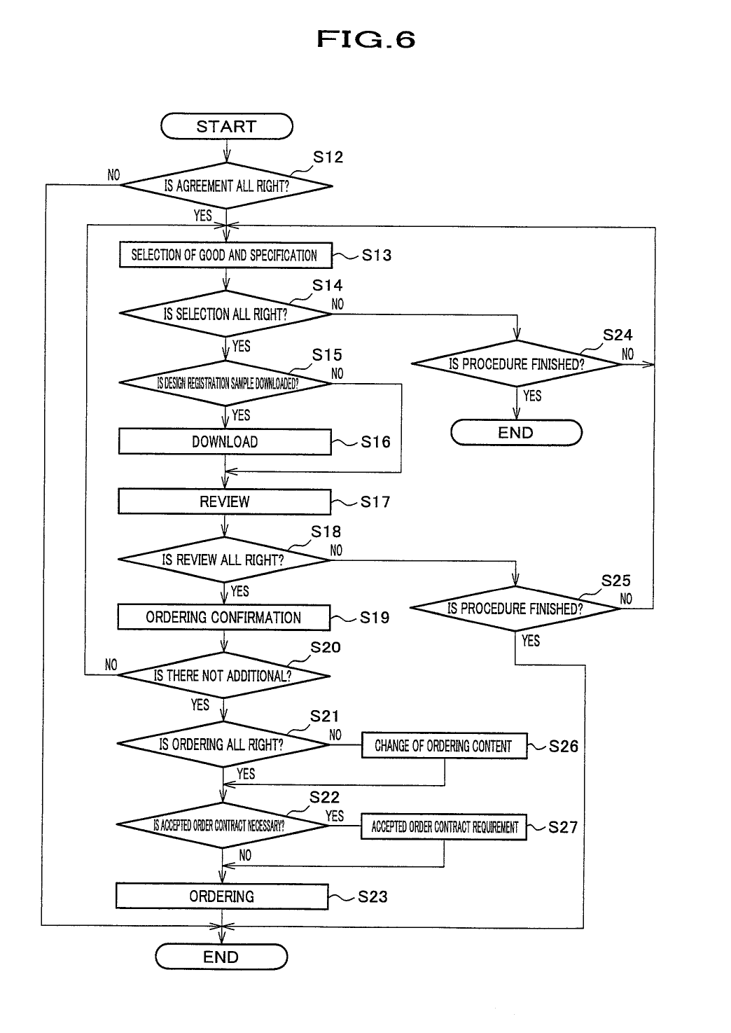

Model selection sample means obtains image data of design sample in which the other specification is colored in model in model of selected good and image data of design sample specification image synthesized by computer graphic and functions to download data to desired information terminal T (See FIG. 6).

Accepted order means is program to accept order from information terminal T of customer.

There are programs of customer management means, authentication means, design sample producing means, accepted order contract confirmation means and manufacturing arrangement means which operate to associate with accept order means and they make made-to-order system (hereinafter referred to as present system) work by each operation.

Customer management means has quite close on taking into consideration collecting fee by association with fee collection means (not shown) and customer registered to present system is security managed with well-known authentication means by ID number and password. Description is omitted.

Accepted order contract confirmation means comprises program: in which design sample which requirement specification of customer of made-to-order is sufficiently taken into consideration, which is picture explained by pattern of drawing colored requirement specification etc. and which is displayed by design sample producing means, and ledger which is mentioned unit price, quantity, scheduled delivery date, and other commerce transaction conditions; are dealt between customer and business owner.

Manufacturing arrangement means corrects description of ledger determined by program of accepted order contract confirmation means to print out corrected one and purpose is carried out by delivering printed note into manufacturing studio or by transmitting it by e-mail.

Price, scheduled delivery date, and place to be delivered etc. are slightly corrected on accepted order contract verification contracted between customer and business owner (it is not limited to paper but is called tentatively). There is program to translate corrected accept order contract verification into manufacturing instruction document (it is not limited to paper but is called tentatively). Although, deservedly, predetermined gap for price and scheduled delivery date to be presented between customer and manufacturing studio is provided, specification and quantity therebetween are the same. Although appropriately quality management means is provided when product is directly sent from manufacturing studio to customer, description is omitted.

DB management means has function to register data to each DB and update-register data, which has been registered. For example, data is registered to customer DB 100 via this DB management means when new customer is registered.

[DB]

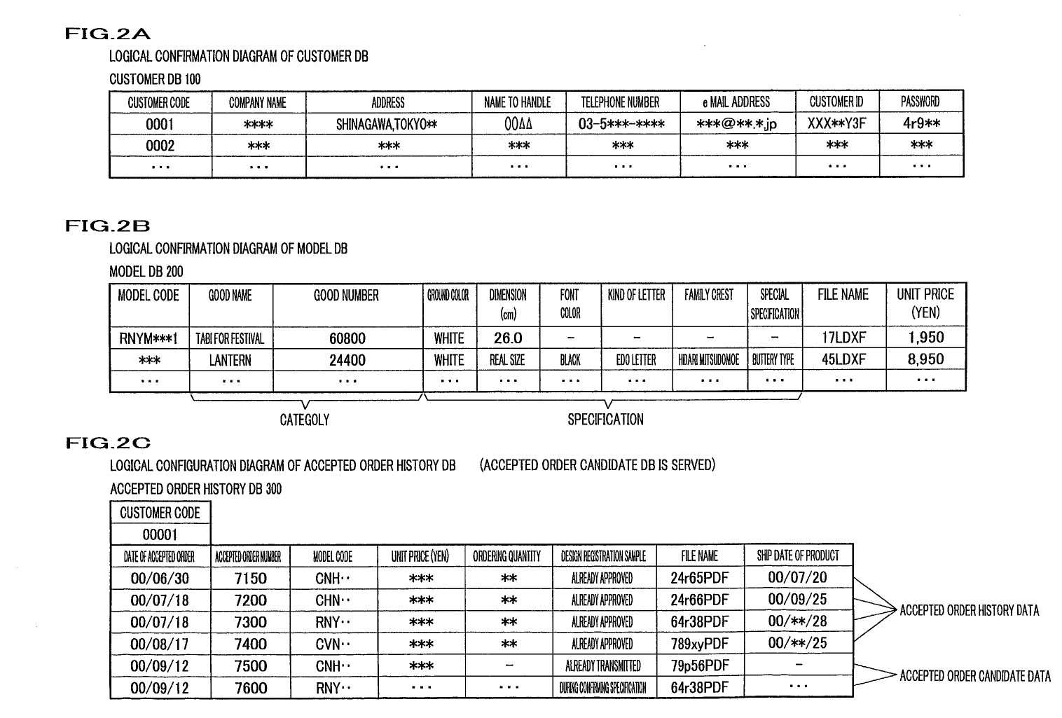

DB etc. which memory device SV2 has is described referring to FIGS. 2A and 2B (See FIG. 1 appropriately).

Here, FIG. 2A shows logical configuration diagram of customer DB, FIG. 2B shows logical configuration diagram of model DB, and FIG. 2C shows logical configuration diagram of accepted order history DB.

Customer DB 100 has items (fields) of customer code, company name, address, name of a handling person, keyboard number, email address, customer ID, and password as shown in FIG. 2A. Customer ID is set to MASAONAKAGAWA, or password 7877X etc. within limiting number and letter by customer or customer ID is automatically assigned at business owner side.

Since fee settlement is carried out by fee collection means connected directly with automatic deduction machine (not shown) fee collection of system is based on practice of commerce transaction by Internet.

Although system is linked to place to which product is sent, it is desirable to be able to set another field taking into consideration in a case where address to be sent is different to aforementioned address.

In short, it preferably has a field to set not shown special circumstances.

As shown in FIG. 2B, FIG. 2B is logical configuration diagram of model DB has fields of model code, good name, good number, ground color, dimension, font, kind of letter, family crest, special specification, file name and unit price. Field can increase and decrease if required. Good name and good number are category, and from ground color to special specification are specifications. This model DB 200 is set corresponding to business content. In other words, model DB 200 is “Half completed model image for made-to-order”.

“Design sample” is made by image synthesizing “Half completion” into “Image of completed product”.

Concrete means of image synthesis can supplement graphic of all design sample by simple software

or develop typed combination of software having function of general-purpose computer graphic used at design office etc. or software having graphic function similar to former software.

However, immediate conclusion of business negotiation is not reached in interactive form of customer and this system, and some operation time is required since operation by dedicated operator is required.

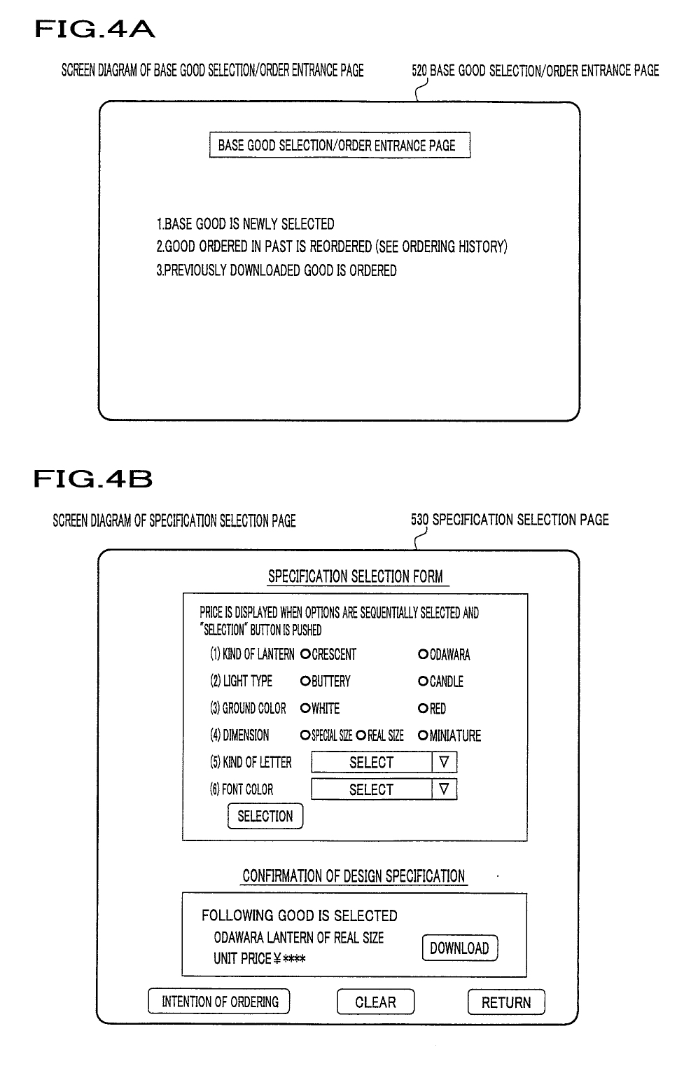

Simple specialization is to be configured such that graphic of design sample of made-to-order which customer desires (not shown) is completed by instructing at several times with known mouse and keyboard from information terminal T and confirmation is instantaneously made by customer at sight (See FIG. 4). Customer can adeptly conclude business negotiation in interactive form between customer and present system instead of limiting use. This function is main subject matter of present invention.

Develop typed combination is made-to-order system with self-learning function and contributes to production planning and goods project for every season since trend of demand can be caught by stocking accepted order history DB 300 as shown in FIG. 2C.

In particular, it is possible to instantaneously deal with repetition ordering to specify identified design sample.

Concrete program is not shown, however, if customer is known, person recalls “Recommend good” which should be introduced only heard the customer name at time of serving customer and “Recommend good suggest function” equal to imaging recommend good can be provided.

“Already approve” of design sample in FIG. 2C means that design sample which business owner is presented is matched to made-to-order specification of customer and is approved. “Already transmit” means state where design sample which business owner is presented is transmitted to customer and approval is pending.

“During confirming specification of design sample means state where made-to-order specification is not agreed between customer and business owner.

In this case, made-to-order system 1 also needs business owner assistance.

To require negotiation of sales man is limited to only case where conclusion of business negotiation with computer is hard. Therefore, business owner can concentrate on business sales in global range or original good project.

[Homepage]

Each homepage of electric commerce transaction in made-to-order system 1 of FIG. 1 is described along FIGS. 3 to 5.

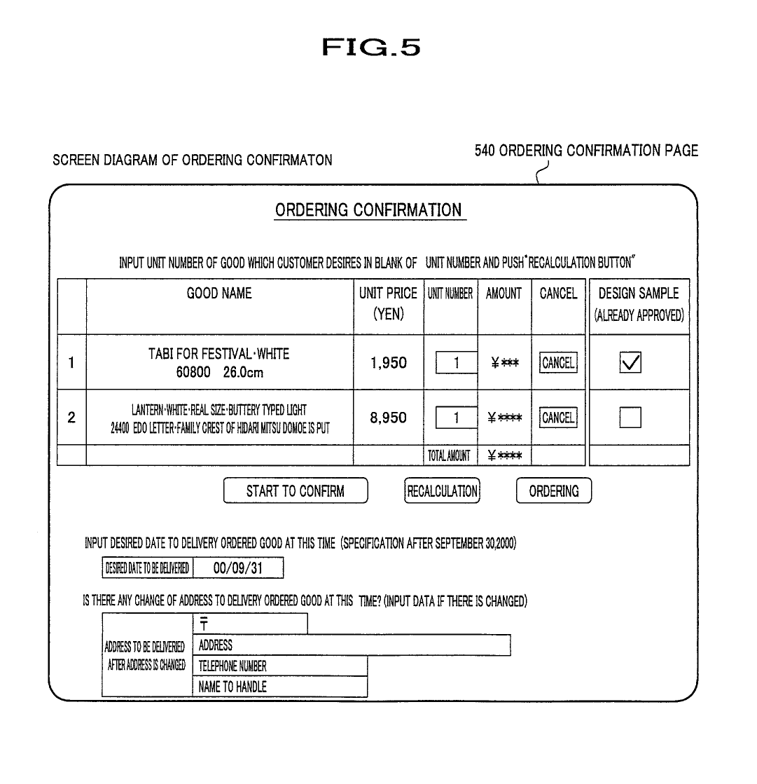

FIG. 3A is a diagram of homepage screen of electric commerce transaction and FIG. 3B is a diagram of screen of customer registration page. FIG. 4A is a diagram of screen of base good selection/order entrance page and FIG. 4B is a diagram of screen of specification selection page. FIG. 5 is a diagram of screen of ordering confirmation.

Homepage 500 is opened with title of “Nakagawa of madeto-or-der” as shown in FIG. 3A. Overall dealing contract condition etc., for example, “Manufacturing arrangement is made after payment in advance is confirmed and paying back is not basically admitted with respect to made-to-order” in electric commerce transaction is mentioned on blank of “Information for first customer”. Business negotiation with made-to-order system 1 is started by customer clicking mouse button of “Agreet” in this screen.

If customer does not agree, it is possible to close homepage 500 since button “Disagree” is link-set to homepage of suitable search engine etc.

Screen goes to FIGS. 4A and 4B by inputting customer ID and password and by clicking mouse button of “Authentication” by customer who already has had customer ID on blank of “Customer having had customer ID”, and business negotiation with made-to-order system 1 is started.

Business approach is in keeping with level of trust, priority of deferred payment is given to customer having had customer ID who is different from customer who starts from blank “Information for first customer”.

Distinction is managed by customer DB 100 and various kind of dealing condition: judgment reference should be applied in usual commerce transaction, is stored. Updating is free (not shown).

Predetermined customer registration information is input into each blank in FIG. 3B. Particularly, explanation is not necessary.

Security protection is provided since information is associated with not-shown fee collection means.

When customer has input predetermined information, screen goes to FIG. 4A by clicking mouse button of “Transmission”. When customer clicks mouse button of “Return”, screen returns to homepage 500 in FIG. 3A.

Screen is used not only for first customer but also for procedure etc. to update input customer registration information and concrete detail is omitted.

Screen of base good selection/order entrance page 520 includes fields of “1. Base good is newly selected.”, “2. Good ordered in past is reordered.” and “3. Good previously downloaded is ordered.”. These are link-set to corresponding page. For example, when number 1 in FIG. 4A is mouse clicked, distinction is selected in not shown base good selection screen.

In detail, customer selects distinction of, for example, number 1. “Lantern” 2. “Slip of paper printed with name of pilgrim” 3. “Jacket” 4. “Shirt with neck of carp mouth shape” 5. “Long underwear” 6. “Long underwear with pattern” 7. “Waistcoat having a front but no back” 8. “Japanese towel” 9. “Tabi” 10. “Straw sandal” 11. “Name seal” 12. “Strap for cellular phone” on screen, which presents option of good group along business content.

Next, screen goes to screen of specification selection page 530 in FIG. 4B and the customer determines good specification which is desired along specification selection form.

“Base good selection” means preparation stage, which is to be state where model of state of rough sketch of coloring is presented as well as drawing pattern and coloring which customer specifies are awaited. If “Lantern” of aforementioned item 1 is selected, “Odawara” of (1) kind of lantern is selected, “Buttery type” of (2) light type is selected, “White” of (3) ground is selected, “Real size” of (4) dimension is selected, “Edo letter and family crest” of (5) kind of letter is selected, an “Family name” in black and ┌Hidari mitsudomoe┘ such as clover mark of kind of family crest in black” of (6) font color is selected on “Specification selection form” in FIG. 4B, customer clicks mouse button of “Selection” when customer who orders good confirms these specifications on selection screen and decides intension.

“Odawara lantern of unit price * * yen was selected” is displayed on “Confirmation of design specification” at lower portion of screen in FIG. 4B, design sample which customer desires (“Design specification figure” or “Design sample” is called) is image synthesized with computer graphic and customer judges design sample of clear color image by mouse-clicking button of “Download”.

Since method in which content is displayed on one part of specification selection page 530, screen is switched into other screen, or switched screen returns to previous screen can be set to any up to program of made-to-order system 1, description is omitted.

Since lantern on which family crest and family name are written is just to write font which customer specifies on half completed product, great time to cite several kinds from model DB 200 and to image-synthesize is not required. Therefore, customer can confirm specification of ordering content in interactive form with unmanned made-to-order system 1, which is far by information terminal T within reach of customer.

“Design” and “Design” are described as the same meaning. However, “Design” is displayed on screen which customer looks at directly so as to easily understand and “Design” for including meaning of “Plan” by customer may be interpreted.

Screen is switched into ordering confirmation page 540 shown in FIG. 5 as decision of impression of customer is almost made by mouse-clicking ordering schedule button on bottom left of specification selection page 530. Content of intention expression of customer at specification selection page 530 is already reflected to screen of ordering confirmation page 540 in FIG. 5.

Ordering confirmation page 540 as shown in FIG. 5 corresponds to accepted order content confirmation means and includes ordering confirmation ledger, start button of confirmation, recalculation button, and ordering button. Ordering confirmation ledger has fields such as good name, unit price, unit number, amount, cancel, design sample, and total amount. These fields can increase and decrease if required.

Good indicated on ordering confirmation ledger is good of object of made-to-order displayed customers intention expression content at specification selection page 530 and method of setting specification is aforementioned described.

Necessary correction can be made on this screen by mouse-clicking button of unit number, cancel, or design sample if changing or canceling description in ordering confirmation forms is required. If increase of quantity from one to five is desired, cursor is moved to corresponding button and number is corrected.

If recalculation button is pushed afterwards, total amount is correctly recalculated and is displayed.

Entire line of the corresponding good is cancelled by mouse-clicking cancel button if description is desired to cancel. Total amount is correctly recalculated and is displayed when recalculation button is pushed afterwards.

When “✓” checkmark is displayed on field of design sample, approval has already been made by design sample at that time and this means that related party can be relieved since there is record which customer bought good with respect to this good in past. When “✓” checkmark is not displayed adversely, it is desirable to reconfirm authorization by new design sample by returning screen to specification selection page 530 in FIG. 4B and the like since there is no record which customer bought this good in past.

Screen is switched from ordering confirmation page 540 into specification selecting page 520 etc. by providing with button switching screen other than by mouse-clicking design sample. When “✓” checkmark is not displayed on field of design sample, any confirmation means passes and whether or not ordering can be made after confirmation means passes can be set up to program of made-to-order system 1.

It is desirable to provide with process of intension decision by double action to avoid careless error, which usually happens, cursor turned field at left end in one line of ordering confirmation ledger etc. into highlight state etc. is displayed by mouse-clicking confirmation start button in present embodiment, ENTER key of keyboard (not shown) is pushed, cursor is moved one field to right end, and confirmation working sequentially processes. Finally, it is considerable that overall confirmation is completed when cursor reaches bottom line or lower right of the last of ordering confirmation page 540.

Ordering is carried out by mouse-clicking order button.

There are fields of date when delivery is required and address to be delivered after address is changed at lower portion of ordering confirmation page 540, customer writes date when delivery is required when ordering good, address to be delivered is automatically displayed from accepted order history DB 300 if one exists and address to be delivered is automatically displayed by citing data from customer DB100 if there is, and customer confirms date and address for every order.

[Procedure Ordering Intention Decision of Customer]

Procedure ordering intention decision of customer in made-to-order system 1 is described referring to flowchart of FIG. 6.

Since procedures etc. from connection information terminal T to internet to accessing homepage in made-to-order system 1 and to disconnection information terminal T from network after completing ordering are known, they are omitted. Therefore, steps from S12 to S27 in FIG. 6 are only procedures of ordering intention decision of customer.

Customer accesses homepage 500, judges whether or not he agrees to basic rules for methods of payment (not shown) mentioned in information for first customer (S12), and mouse-clicks agree button in homepage 500 when he agrees. Screen of base good selection/ordering entrance page 520 is displayed and dummy business negotiation of both customer and made-to-order system 1 in interactive form is started.

Since handling of customer registration, customer ID and password is known, it is omitted.

If customer mouse-clicks “Disagree” button, disconnection to home page 500 in made-to-order system 1 is performed, and then linkage connection to appropriate search engine screen etc. (not shown) is performed and access is finished.

If base good of field 1 newly selected is selected by mouse-clicking button or pushing keyboard at base good selection/ordering entrance page 520, good is selected at not-shown base good selection screen.

Customer selects distinction of, for example, “Lantern” or “Tabi” on screen where option of group of goods along business content is displayed.

Customer determines desired good specification along specification selection form at specification selection page 530 (S13), he mouse clicks selection button if he who is person to order confirms good specification and decides his intention (S14).

If download is necessary to judge design sample (S15) download is performed (516). Customer reviews design sample (S17), confirms ordering content on screen at ordering confirmation page 540 (S19) if design sample is met (S18), judges whether or not there is addition (S20). If there is addition, screen returns to base good selection/ordering entrance page 520 or specification selection page 530, customer determines good specification which he desires along specification selection form (S13) and adds ordering.

Customer judges whether or not correction of ordering content is necessary (S21); screen returns to ordering confirmation page 540 or specification selection page 530 if correction is necessary; and he corrects, cancels or reinputs ordering content (S26). Part of title of ordering confirmation page 540 is changed to “Accepted order verification” by requiring issuance of accepted order contract (S27) if issuance of accepted order contract is necessary (S22). Image information in which design sample already approved is mentioned on same page (not shown) and can be printed out may be taken out from information terminal T of customer (instruction button etc. is not shown). Whether or not he prints out accepted order verification is up to decision of customer, and does not affect on business owner of made-to-order system 1, and content of accepted order is confirmed on system regardless of presence of printed-paper of accepted order verification.

Information communication is essential via step (not shown) of intention confirmation of business owner of made-to-order system 1 (this step includes step 27 and is not shown) if accurate scheduled delivery date confirmation and screen display of that date or written on paper are necessary on practice of commerce transaction and information communication becomes confirmation means for confirming whether or not accepted order contract is accepted. Since concrete means is obvious, description is omitted.

Although ordering confirmation page 540 is displayed at many times while sequential ordering procedures from (S12) to (S22) passes, ordering is made by mouse-clicking “Order” button at ordering confirmation page 540 (S23) when customer ordering plan ripens and intention is decided.

Intention expressed information of made-to-order of customer is easily, sure, and accurately sent to business owner via made-to-order system 1.

If selection of good specification does not meet to desire of customer as result of judgment at step (S24) or step (S25) in flowchart shown in FIG. 6, procedure returns to good and good specification and it is possible to rework or stop specification decision while working.

It is desirable to indicate rule that made-to-order in which design sample has sufficiently been reviewed (S18) and made-to-order has been ordered once (S23) cannot be cancelled on homepage 500.

It is object of the present invention to get rid of error ordering due to anachronism.

Fee collection means on prepayment and deferred payment is inevitable and important on commerce transaction. However, since fee collection means goes off main point of this invention, description in detail is omitted.

[Customer Registration]

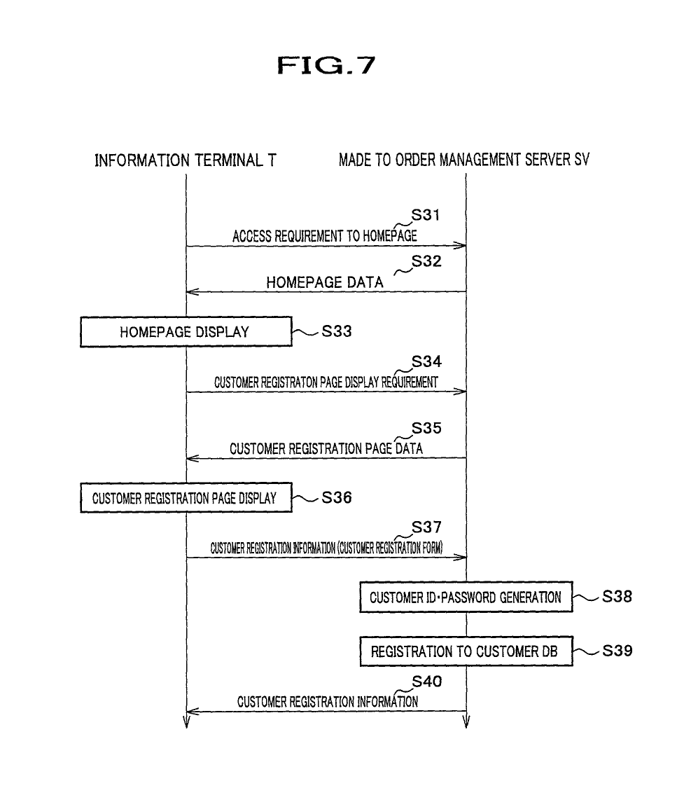

Operation when customer registration is made is described referring to sequence chart of FIG. 7. Reference numerals from S31 to S40 described below show each step in sequence chart of FIG. 7. FIGS. 1 to 6 are appropriately referred.

Access requirement to homepage 500 is performed by inputting URL of made-to-order system 1 with information terminal T close at hand (S31). Made-to-order management server SV transmits homepage data to information terminal T according to its requirement (S32). Homepage 500 is displayed on information terminal T of customer by this transmission (S33).

Customer registration page display requirement is made against made-to-order management server SV by customer registration button of homepage 500 (S34). Data of customer registration page 510 returns to information terminal T (S35) and customer registration page 510 is displayed (S36). Customer inputs customer registration information such as company name, address, name of a handling person, keyboard number, e-mail address, and other (not shown) into information terminal T along customer registration form and transmits information to made-to-order management server SV (S37).

If his mind is changed before information is transmitted, screen returns to homepage 500 from customer registration page 510 by pushing “Return” button, and information terminal T is disconnected from homepage 500 when button “Disagree” is pushed in screen and homepage 500 is closed.

Made-to-order management server SV may assign customer ID/password generation (S38) semi-automatically and favorably for self-identification code of customer may be reflected.

Priority of dealing is ranked for customer to whom customer ID/password is assigned based on known customer management means and close communication between customer and made-to-order management server SV is allowed by customer ID/password inputted into field of authentication information of homepage 500 for every access and by pushing “Authentication button”.

Customer registration information is previously registered to customer DB100 so as to search information freely (S39) and is updated. Since customer DB100 records address where product is sent to and address to be contracted, direct mail can be made.

It is relieved to inform customer registration (S40).

[Selection of Model and Download of Design Sample Data]

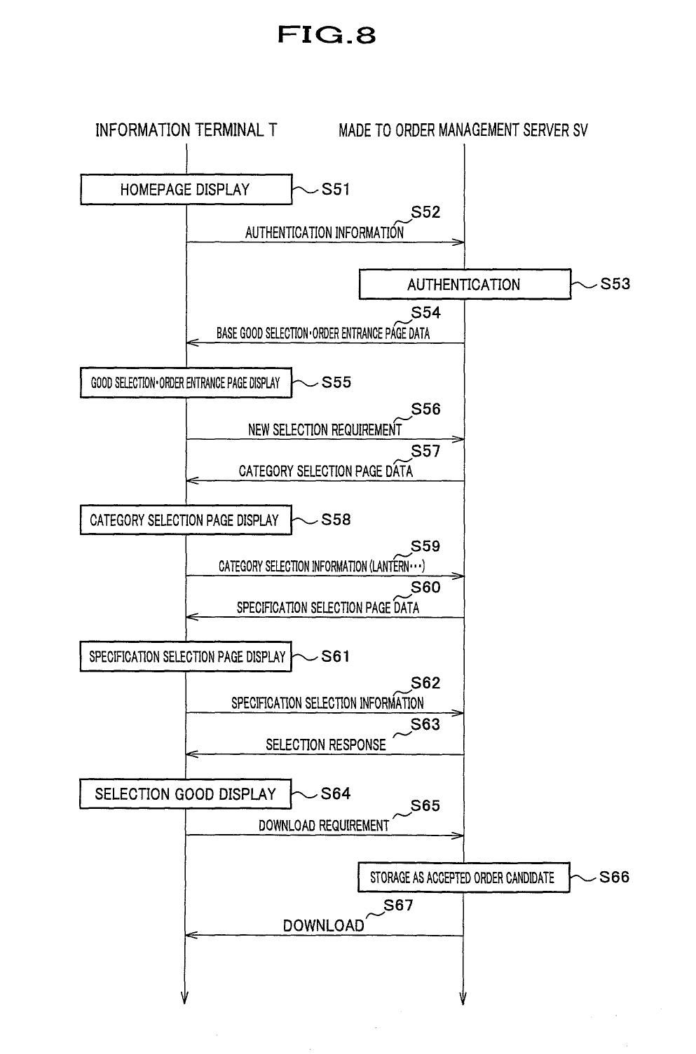

Operation when registered customer selects model and downloads design sample data is described referring to sequence chart of FIG. 8. Numerals S51 to S67 show each step in sequence chart of FIG. 8. Following explanation is appropriately described referring to FIGS. 1 to 6.

Customer accesses homepage 500 by information terminal T, made-to-order system 1 is displayed on information terminal T (S51), authentication information is transmitted from information terminal T to made-to-order management server SV by inputting customer ID/password and by pushing “Authentication button” (S52), transmitted information is compared with customer data in which customer data-based 100 in made-to-order management server SV, authentication is made if data is matched to pertinent person (S53), and close communication of customer with made-to-order management server SV are allowed afterward.

Data of base good selection/order entrance page 520 returns to information terminal T from made-to-order management server SV (S54) and base good selection/order entrance page 520 is displayed on information terminal T (S55).

Category selection page data returns to information terminal T from made-to-order management server SV (S57) and category selection page (not shown) is displayed (S58) if new selection of base good is required (S56).

Category selection information which customer designates, for example, “Lantern” is transmitted from information terminal T to made-to-order management server SV (S59), data of specification selection page 530 corresponding to “Lantern” returns (S60) and specification selection page 530 is displayed on information terminal T (S61).

Selection reply of “Odawara lantern ¥* * * with real size” etc., that is, acceptance information returns (S63) and selection good is displayed on lower portion of specification selection page 530 (S64) if customer input specification selection information on screen in aforementioned manner and information is transmitted from information terminal T to made-to-order management server SV (S62).

Design sample and displayed description of ordering confirmation page 540 established on business owner side at this stage are stored as accepted order candidate (S66), and design sample is downloaded to information terminal T (S67) if customer transmits download requirement to made-to-order management server SV by pushing button of download of specification selection page 530 (S65).

Subject matter of present invention is that good specification which customer desires is mutually understood in easy interactive form by close communication of information terminal T with made-to-order management server SV, design sample in which recognition should be common is downloaded to information terminal T (S67) and confirmation means for confirmation whether or not accepted order contract based on design sample is provided. Therefore, the present invention can be applied to any goods if the aforementioned subject matter is utilized.

Easy made-to-order is available in information communication system which being capable of using portable remote terminal which can access Internet as another embodiment of present invention.

Article is not sold but novel design is made-to-order for background wallpaper of the display screen from portable remote terminal being used (background wall paper is not paper and means background for letter of liquid crystal screen) in embodiment.

Simplified specification selection page 530 for actual good of aforementioned lantern etc. is sufficient as accepted order means to accept order of design creation for design of background to be displayed on screen for display provided on portable remote terminal. Therefore, description is omitted.

Made-to-order system is configured such that desired image is instantaneously displayed on screen for display by downloading creation or image data of design cited from database to portable terminal by customer according to order in which, for example, “Asakusa/Nakaya” is written on slip of paper printed with name of pilgrim in Edo letter.

Fee collection means to collect design creation fee for image data according to downloading or distributing design fee for existing design is provided.

Fee settlement means of, for example, known NTT DoCoMo is used with respect to fee collection means.

There is a little problem even with simple dealing means, which is different from case where comparatively expensive article is sold as mentioned above with respect to means of detail dealing means in case where although customer downloaded image data, data does not fit his desired image. Rather, made-to-order system is configured such that there is import sense to sell interest to easily.

If image producing means of slip of paper printed with name of pilgrim, for providing with design that character or letter in which customer desires is written and design has taste of slip of paper printed with name of pilgrim, has configuration which being capable of made-to-order selling actual good of slip of paper printed with name of pilgrim or name seal, means can sell only image data of design specification figure prior to manufacturing actual good. There is not any difficulty to implement it.

Thereby, design has taste of traditional and attractive slip of paper printed with name of pilgrim can be sales promoted to person interested in Japanese festival of Shinto shrine according to elevation of festival feeling.

As described above, according to the appended claim 1 in the present invention, made-to-order is concluded with a little risk while simplicity of mail correspondence of catalog etc., transacting in a wide area and further use of speedy of electric commerce transaction.

According to claim 2, design example can immediately be presented so long as a specification pattern or description of special specification is not original.

Design sample can be displayed and presented with a little effort based on specification if specification is clear even if specification pattern or description of special specification is original.

Further, since design sample established once is added to database, it becomes possible to instantaneously present design sample for same or similar specification.

Therefore, since new repertory increases by continuing business, it is possible to expect further development of made-to-order.

According to claim 3, manufacturing arrangement is speedy, sure, and accurately available according to order.

According to claim 4, it is possible to cheaply provide with high quality product in a short scheduled delivery date for shortening trouble and the time required to get a large quantity of agreed accepted order contract.

Therefore, it is possible to deal with special demand of a stage good of high tendency to occurrence of demand, which is prominent at the far place in limited period.

According to claim 5 or 6, traditional feeling is easily satisfied.

According to claim 7, the customer who uses the portable remote terminal can easily order charge design to set dedicated or favorite wall paper background design in screen for the display, wall paper background design is instantaneously displayed on the display screen of portable remote terminal and displayed design is fixed.

According to claim 8, design has taste of the traditional and attractive slip of paper printed with name of pilgrim is instantly displayed on a screen of the portable remote terminal to a person interested in a Japanese festival of Shinto shrine and it is fixed. Therefore, sales promotion of the design is available according to elevation of festival feeling.

What is claimed is:

1. A made-to-order system in an electric commerce transaction comprising:
an accepted order content confirmation means for accepting an order from a customer;
a design sample production means for producing design sample including image data based on data of specifications of the accepted order;
a design sample transmitting means for transmitting the design sample to a customer; and
a confirmation means for confirming whether the order contract
is accepted based on the design sample.

2. A made-to-order system as set forth in claim 1, wherein said accepted order content confirmation means is capable of specifying special specifications, special design, size, color, pattern and good name on a screen of homepage;
said system further comprises database storing data of existing specifications, new special specifications and specifications of specific patterns, and an image synthetic processing means for overlapping a database storing specification data of existing or new special specification and specific pattern so as to search them freely and specification data cited from the database with a half completed model image by a computer graphic.

3. A made-to-order system as set forth in claim 1 or 2 further comprising a manufacturing arrangement means having manufacturing instruction form in which design sample is main.

4. A made-to-order system as set forth in any of claims 1 to 3, wherein the system deals with a stage good for festival or various events.

5. A made-to-order system as set forth in any of claims 1 to 4, wherein a family crest is put on a product to be applied.

6. A made-to-order system as set forth in any of claims 1 to 5, wherein Edo letter is put on a product to be applied.

7. A made-to-order system as set forth in claim 1 or 2 further comprising an accepted order means for accepting order of design creation for a background design to be displayed on a display screen provided on a portable remote terminal; and
a fee collection means for collecting a fee for producing design of the image data by downloading image data of design creation created according to the ordering to said portable remote terminal by said customer or a fee for distributing an existing design; said system being utilized in an information communication system capable of using said portable remote terminal which can access Internet.

8. A made-to-order system as set forth in any of claims 1, 2 or 7 further comprising an image producing means for producing a slip of paper printed with the name of a pilgrim and providing design in which character or letter that customer desires is written.
